(19) United States
(12) Patent Application Publication
(10) Pub. No.: US 2015/0154382 A1
(43) Pub. Date: Jun. 4, 2015

(54) CLINICAL TRIAL DATA CAPTURE

(71) Applicant: Icon Clinical Research Limited, Dublin (IE)

(72) Inventors: Brendan BUCKLEY, Limerick (IE); Wojciech SIEMIATKOWSKI, Limerick (IE); Gareth MILBORROW, Limerick (IE)

(73) Assignee: ICON CLINICAL RESEARCH LIMITED, Dublin (IE)

(21) Appl. No.: 14/554,183

(22) Filed: Nov. 26, 2014

(30) Foreign Application Priority Data
Nov. 29, 2013 (EP) 13195159.2

(51) Int. Cl. G06F 19/00; H04L 29/06

(52) U.S. Cl. CPC G06F 19/363; H04L 63/107; G06F 19/322; G06F 19/327

(57) ABSTRACT

A clinical trial data capture system has clinical site computers (6), each registered with a site and having thick client software, and a server (2) programmed to receive clinical data from the site computers and to analyse said data in real time. The server (2) automatically determines if a site computer is outside of an allowed region, indicating unauthorised use, and takes an action such as clearing the computer's data. Each site computer performs cycle management by maintaining a workflow (14) per patient, and imposes a consent gate through to subsequent workflow stages of patient treatment with n visits V₁ . . . Vᵢ . . . Vₙ, and treatment follow-up. A distribution lplot is generated (27) for parameters when data is close to thresholds and a threshold may be automatically modified accordingly.

### INTRODUCTION

1. Field of the Invention

The invention relates to technical aspects of capture of clinical trial data by investigators, and to downstream processing.

2. Prior Art Discussion

In order to conduct a reliable clinical trial or study for a drug it is necessary to have as large a number of patients participating as is feasible. Where the drug is for treatment of an illness such as cancer the number of patients participating in a study will of necessity be limited. However for many trials the treatment is for a more common and less serious illness such as diabetes and so it is possible to have several thousand participants.

Such trials typically involve use of several tens of sites at distributed locations. A problem heretofore is that due to different standards prevailing in different regions, and due to fluctuating factors such as the available time that a clinician has, the quality of data capture can be varied. As a result, it has often been the case that a trial sponsor discovers very late that there is a problem with a drug for a particular type of patient. Another problem is that incorrect capture of data or early misinterpretation of it may cause an unnecessary halt to a trial. Such errors can at worst cause patient illness or even death, and at best loss of large sums of money by the sponsor.

U.S. Pat. No. 8,165,892 (Carter et al) describes a method for automatically monitoring drug packaging in clinical trial processes.

The invention is directed towards providing a technical infrastructure with automation to help improve integrity of clinical data.

### SUMMARY OF THE INVENTION

According to the invention, there is provided a clinical trial data capture system comprising:
a plurality of clinical site computers, each configured to be registered with a clinical trial site and having thick client software, and
a server configured to receive clinical data from the site computers and to analyse said data in real time.

In one aspect, at least one site computer:
includes location tracking capability and is configured to automatically upload location data to the server, and the server is configured to log said data,
is configured to automatically upload patient site visit data to the server, and to also save site visit data to a document and to upload said document to the server, and
has a camera and is configured to capture an image related to a clinical visit and to upload said image with associated clinical visit data.

In one embodiment, the server and/or at least one site computer are configured to automatically determine if a site computer is outside of an allowed region, indicating unauthorised use.

In one embodiment, the server is configured to, if a site computer is outside of an allowed region, lock the site computer, or clear the site computer's data, or change the computer's access credentials. In one embodiment, at least one site computer is configured to block re-entry of data to a field according to data validation criteria. In one embodiment, at least one site computer is configured to analyse data and display decisions based on evaluation of formal expression.

In one embodiment, at least one site computer and/or the server are configured to automatically detect a medical adverse event by analysis of inputted patient data. Preferably, at least one site computer is configured to perform the following steps:
receive an entry of a patient data,
comparing the entered data with allowed ranges, and
if the automatic analysis reveals a possible adverse event but with only a small margin, generate a distribution plot for at least one parameter, and
upload said distribution plot data to the server, and

wherein the server is configured to then make a determination of an adverse event.

In one embodiment, at least one site computer is configured to perform the following steps:
receive an entry of a patient data,
dynamically carry out a plausibility check by comparing the entered data with allowed ranges, and
if the automatic analysis reveals that the patient candidate should not be accepted, but with only a small margin on some parameter, generate a distribution plot for this parameter over a number of candidates, and
upload said distribution plot data to the server, and

wherein the server is configured to then make a determination as to candidate eligibility and compares it to that made by the site computer.

In one embodiment, at least one site computer is configured to maintain an audit trail of data allowing subsequent answers to questions about a clinical trial, wherein very time when a user who is in offline mode changes the data state the computer will persist a new data state in a separate data table and deliver this when connectivity to the server is possible.

Preferably, the site computer is configured to perform rendering of forms based on an operational data model protocol definition to render any fields as a widget type of date or time or a close section list or a text area or a checkbox, and the site computer is configured to perform data validation using value ranges and checking required field values and to automatically perform dynamic calculations between fields in a form.

In one embodiment, the site computer is configured to use JavaScript language as formal expression to perform said validation. In one embodiment, the site computer is configured to automatically detect attempted image editing and to upload corresponding alerts to the server.

In one embodiment, at least one site computer is configured to automatically perform cycle management by maintaining a workflow per patient. In one embodiment, at least one site computer (6) is configured to automatically impose a consent gate through to subsequent workflow stages of patient treatment with n visits V₁ . . . Vᵢ . . . Vₙ, and treatment follow-up.

In one embodiment, at least one site computer is configured to automatically impose a discontinue gate before entering the follow-up stage. In one embodiment, at least one site computer is configured to dynamically modify a visit schedule to generate data for a next visit Vᵢ₊₁.

In one embodiment, said data includes clinical instructions dynamically retrieved from a configured clinical instruction profile. In one embodiment, a decision to schedule a next visit Vᵢ₊₁ is triggered according to comparison of clinical data with thresholds.

In one embodiment, the consent gate requires patient inputs confirming understanding of each of a plurality of topics, and a sub-gate is imposed to prevent automatic generation of a consent form until all topics are confirmed to be understood by the patient. Preferably, at least one site computer is configured to generate a display of summarising topic headers adjacent a patient-understanding input, thereby prompting the investigator to explain further.

In one embodiment, at least one site computer is configured to generate the consent form with patient data and topic data and a control for touch-screen writing of a consent signature. In one embodiment, at least one site computer is configured to impose a sub-gate for investigator witnessing of the consent signature before progressing beyond the consent stage.

In one embodiment, at least one site computer is configured to require an investigator to input an electronic signature for accepting satisfactory witnessing of a patient consent signature. In one embodiment, the server is configured to perform electronic data capture by automatically transferring processed and raw data to an external EDC system.

In one embodiment, at least one site computer is configured to download a batch of enrolment codes and store them locally, in which there is one enrolment code per patient, and to make said enrolment code available even if the site computer is offline, and wherein at least one site computer is configured to automatically synchronize with a server when next online, by uploading which codes have been used. In one embodiment, at least one site computer is configured to automatically download a fresh batch of enrolment codes during said synchronization.

In one embodiment, at least one site computer is configured to download a batch of randomisation codes and store them locally, in which there is one randomisation code per patient, and to make said randomisation code available even if the site computer is offline, and is configured to automatically synchronize with a server when next online, by uploading which codes have been used, and is configured to automatically download a fresh batch of randomisation codes during said synchronization.

In one embodiment, at least one site computer is configured to, upon completion of a data entry, request a list of dispensing codes for the patient from the server or from an interactive response system, allowing only one dispensing code per bottle or packet of medication, and wherein at least one site computer is configured to capture a scanned identifier of medication physically provided to the patient, and the site computer and/or a server are configured to automatically check the scanned identifiers against inputted codes for the patient.

### DETAILED DESCRIPTION OF THE INVENTION

### BRIEF DESCRIPTION OF THE DRAWINGS

The invention will be more clearly understood from the following description of some embodiments thereof, given by way of example only with reference to the accompanying drawings in which:

FIG. 1(a) is a block diagram showing a clinical trial data capture system of the invention, and FIG. 1(b) illustrates the system in more detail;

FIG. 2 is a flow diagram illustrating control of clinical workflow implemented by the system; and

FIGS. 3 and 4 are flow diagrams showing operation of the system, showing operations such as immediate data validation, assisted modification of thresholds, and merging of image and entered data for locking data integrity.

### DESCRIPTION OF THE EMBODIMENTS

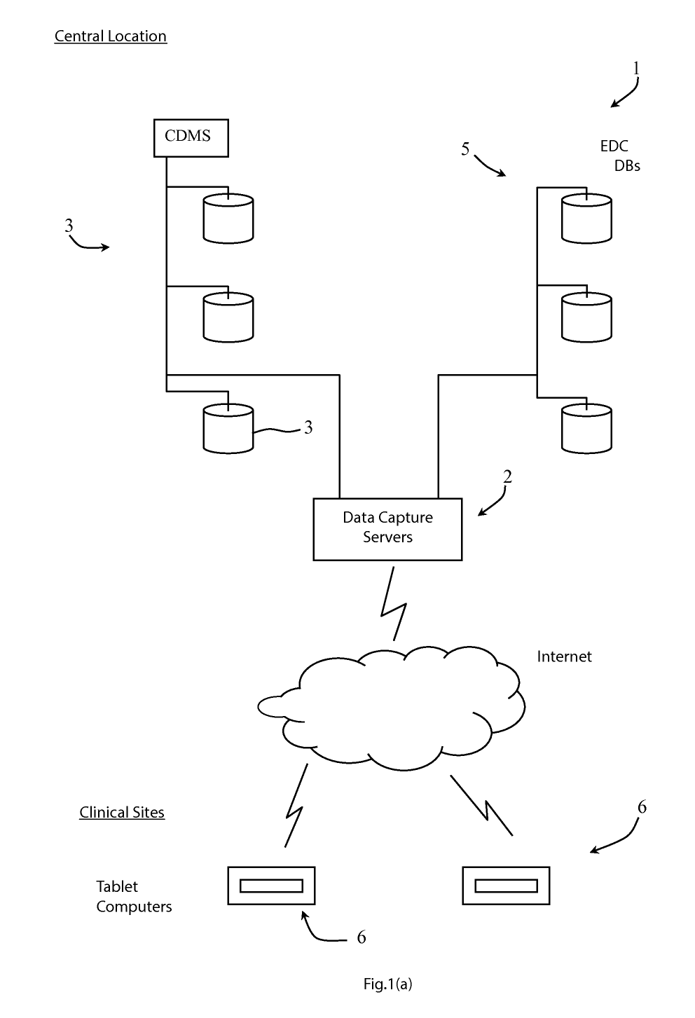

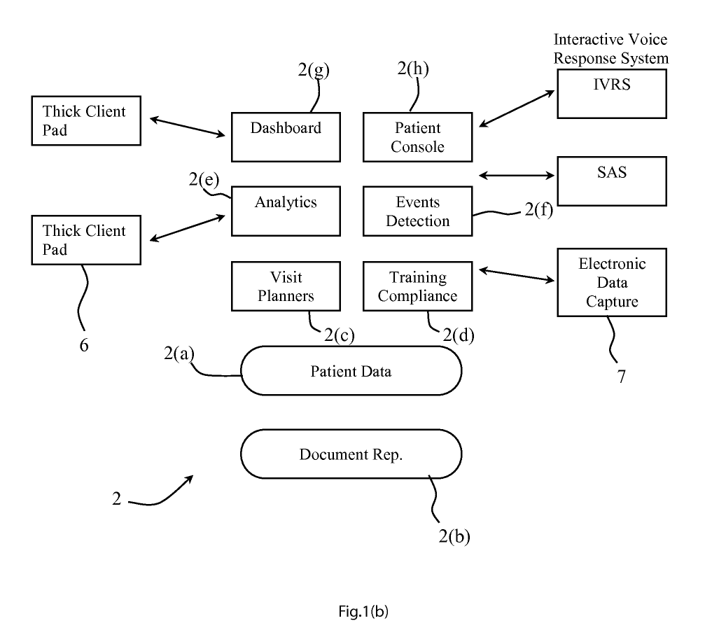

Referring to FIG. 1(a) a clinical trial data management system 1 has application servers 2 and database servers 3 including an electronic data capture (“EDC”) bank of database servers 5. These are linked with the cluster of servers 2 with redundancy and data mirroring, for real time capture of clinical data from remote sites via the internet.

At each clinical site there is at least one clinical site computer 6 with thick client software for locally capturing data from an investigator clinician. The computers may be of any desired type, but will more often be tablets or laptops. The computers 6 also carry out immediate data integrity checks and interface with the servers 2 to initiate actions in real time for optimum performance of a clinical trial and dissemination of information.

Each site computer 6 has an embedded GPS sensor which tracks its location in real time. If one is in a “Faraday Cage” location where it cannot wirelessly communicate, it automatically logs all data locally until it can communicate, especially with the servers 2.

The servers 2 are programmed to automatically detect if a site computer 6 is stolen, on the basis of it being out of a configured geographical region. Additionally or alternatively, a client application on each computer 6 performs such tracking and can generate appropriate alerts. This is described in more detail in the section below entitled “Client Monitoring”.

As a back-up to for some captured and entered data, the thick client software directs the clinical trial investigator to use the computer's camera to capture an image of a paper document, a medical device display, or indeed a visible patient symptom. The software automatically links the captured image with the patient's data record. Integrity of the link between the image and the patient record is ensured by storing relational information assigned to a subject.

Moreover, the thick client software is configured to automatically log any image editing which may be carried out by an application such as an image editor on such captured images.

FIG. 1(b) shows in more detail the inter-connection of the parts of the system 1, referred to as electronic data capture (“EDC”) integration, and links to systems such as an Interactive Voice Response System (IVRS) or an IWRS (Interactive Web Response System) and statistical analysis system (SAS). Each site computer 6 is a standalone unit, which allows working in offline mode. It has its own database, allowing stand-alone operation. The code below under the heading “Data Persistence” demonstrates database persistent API in objective C. FIG. 1(b) shows particularly the links of the servers 2 with Interactive Voice Response Systems (IVRS), SAS systems, and Electronic Data Capture (EDC) systems 7.

The application servers 2 include:

2(a) patient (clinical trial subject) data database;

2(b) document and image database;

2(c) a visit planner application;

2(d) a training compliance application;

2(e) an analytics application;

2(f) an events detection application

2(g) a dashboard application;

2(h) a patient console application.

Each site computer 6 has applications for interfacing with the server applications for data capture, such as a visit planner, a patient console, and a dashboard.

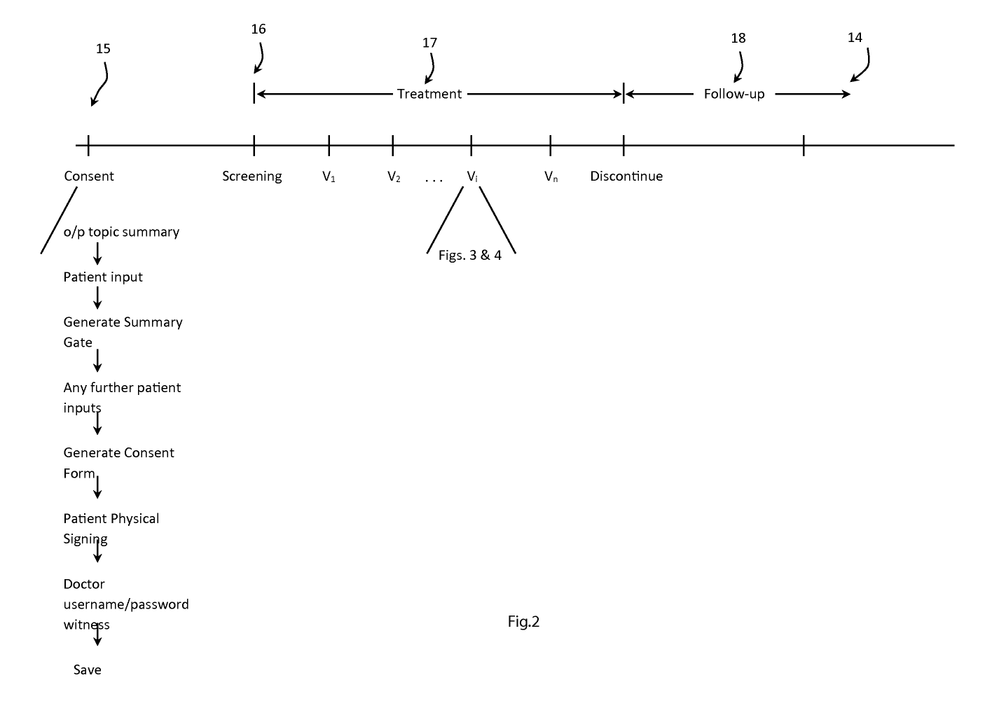

Referring to FIG. 2, the system of the invention automatically implements a workflow 14 with the following stages:
15, patient consent;
16, patient screening;
17, treatment with n visits V₁ . . . Vₙ;
18, follow up.

The medical or clinical aspects are not the subject of this patent application, rather the automated clinical trial data processing and workflow operations performed by the system to ensure integrity of data that is captured and processed.

Before a computer 6 is used in a clinical trial it downloads a batch of enrolment codes and stores these offline. There is one enrolment code per patient, and it is available even if the computer 6 is offline. This permits the doctor to enrol a patient (and assign an enrolment code even when no connection is available). When online again it automatically synchronizes with a server 2, registering the enrolled patients. Typically during such synchronization it downloads a new batch. During synchronization the site computer uploads which codes have been used. For example it may download 10 codes and use 3. It uploads the information that it has used three codes (the backend systems then use those codes for other things) and it then downloads new codes to replenish itself.

Many trials use two codes: an enrolment or screening code and a randomisation code. The system batches both codes. There is a batch of enrolment codes and a batch of randomisation codes. The technical process is identical. The enrolment code is for all patients. However, many studies have a period of time during which the patient is assessed for suitability. They do not receive a study drug during this time. The randomisation code is only for those patients who proceed into the study and are actually assigned a drug.

For patient consent 15 the computer 6 automatically generates a display summarising a consent topic with a prompt for the patient to indicate that she understands that topic. It automatically progresses to the next topic only after receiving a do/don't understand patient input. After all topics have been processed the computer 6 generates a summary display listing all topics and the associated patient response. Where the response was negative the computer 6 generates a display with more detail and (with guidance from the investigator) there will be a positive patient input. The computer 6 then automatically generates a consent form populated with patient data and summary information about what has been understood. It includes in the form a control for physically signing using a touch-screen interface function.

Using receipt of a physical patient signature as a gate the computer 6 automatically prompts the doctor to input an electronic signature using a username and password as a witness. It is only after this has been inputted that the computer 6 allows progression to the screening stage 16. This is largely dependent on the doctor's (investigator's) inputs as this is not amenable to automation.

There is then the treatment stage 17 with visits V₁ . . . Vᵢ . . . Vₙ. The scheduling of this is dynamically controlled in a manner whereby the system dynamically generates a modified schedule with visits Vᵢ₊₁ with timing and medical instructions generated according to data inputted by the investigator during the visit Vᵢ and pre-configured profile data generated when the clinical trial is being set up. For example, a pulmonary test result below a threshold will cause the system to automatically schedule the visit Vᵢ₊₁ with appropriate instructions and a date which is earlier than would otherwise be the case.

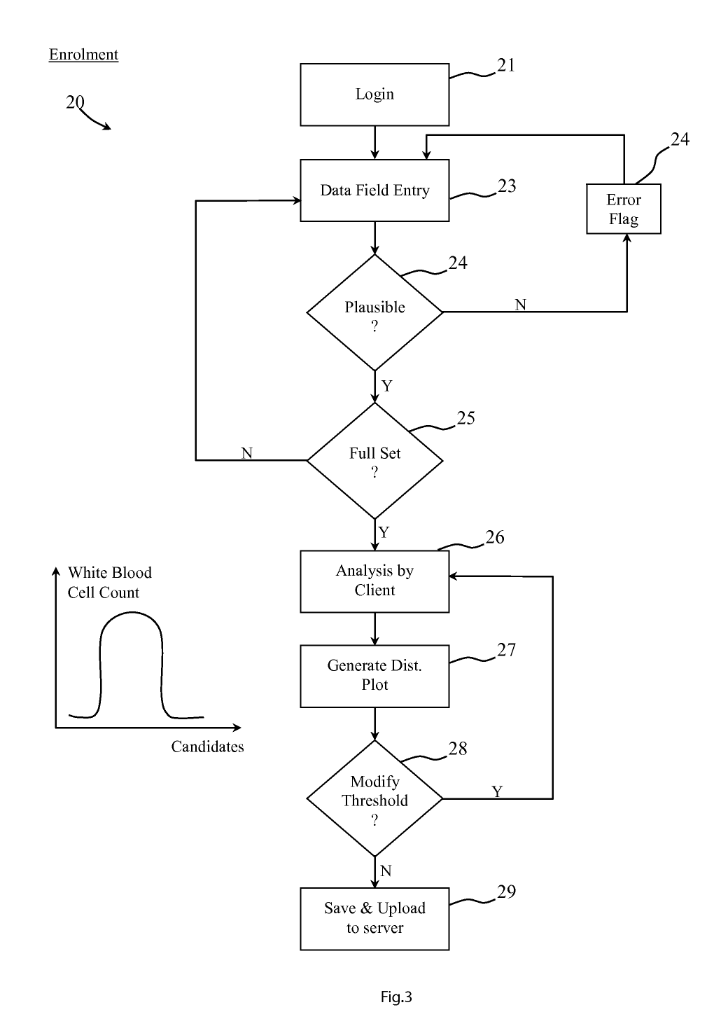

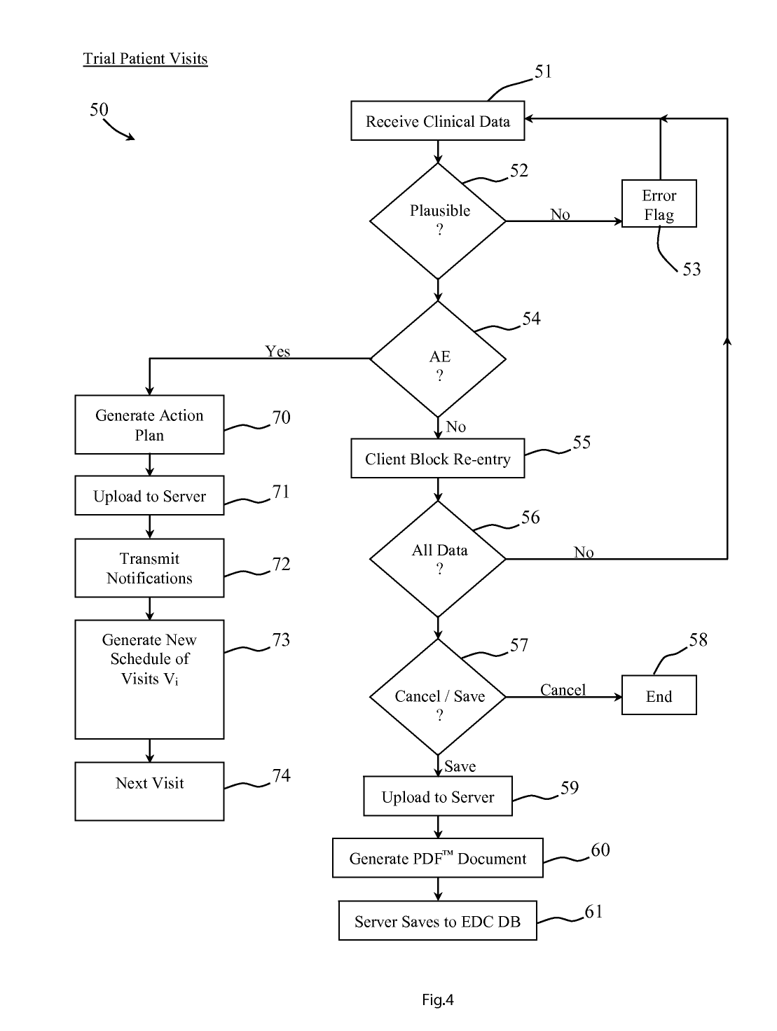

The dynamic scheduling and data capture aspects are described below in more detail with reference to FIGS. 3 and 4.

Referring to FIG. 3 in a method 20 to enrol a candidate patient for a clinical trial, there is initially a login procedure 21 of the site computer 6 to the servers 2.

The steps are as follows:
22, Entry of data to a field such as patient age, gender, or medical treatment history data.
23, The thick client software of the site computer 6 dynamically carries out a plausibility check by comparing the entered data with general allowed ranges. The computer 6 performs rendering of form data with validation.
24, Error flag to investigator, if necessary.
25, Loop back for each fresh data entry to a field.
26, The client software immediately analyses the data.
27, 28 If the analysis reveals that the patient candidate should not be accepted, but with only a small margin on some parameter, the site computer 6 generates a distribution plot for this parameter over a number of candidates. In the illustrated example the parameter is white blood cell count. This provides significant information to the clinician to make an informed decision as to whether the threshold can be modified.
29, The candidate's data is saved and uploaded to a server 2. The server 2 then makes a determination as to candidate eligibility and compares it to that made by the site computer 6. This is performed by the analytics application 2(e).

FIG. 4 shows real time operations 50 during a study, giving the example of a visit by a participating patient. The visits are scheduled on the basis of cycles and days.

The steps illustrated are as follows:
51. Receive an entry such as patient temperature or Force Pulmonary Capacity (FPC).
52, 53 Plausibility check, and error flag if necessary.
54. Dynamic determination by the site computer 6 if there is a medical Adverse Event (“AE”). For example, a low FPC value may indicate a chest infection.
55. If there is no AE the client software blocks data re-entry to this field by formal expression. Formal expression allows creation of more sophisticated validation.
56, 51 If further data is required the method proceeds to the next field.
57, 58 The investigator has the option of pressing a “Save” or “Cancel” button. If “Cancel” the data entry for this visit is ended. The data is logged in a particular database for this purpose by the servers 2 and EDCs 5.
59. With the “Save” option the site computer 6 uploads to the servers 2 and simultaneously prints the data to a PDF™ document. This document is saved locally on the site computer 6 and is uploaded to a server 2.
61. The server 2 saves the uploaded data and documents to the EDC bank 5 Importantly, this procedure means that there is a single non-corruptible record of the combination of data which has been captured for this patient's visit. This very effectively backs up inter-linked data saved to various relational tables in the EDC databases 5.
70, 71 If there is an AE the server automatically generates an Action Plan for the patient-including for example treatment and check-ups.
72, Moreover the server sends notifications to the people configured to receive such information. This allows swift action to be taken if appropriate.
73, 74 The server 2 generates a revised schedule for the patient with at least one additional visit inserted between previously-planned visits.

The site computer may in one embodiment be programmed to receive an entry of a patient data compare the entered data with allowed ranges, and if the automatic analysis reveals a possible adverse event but with only a small margin, generate a distribution plot for at least one parameter. It then uploads the distribution plot data to the server (2), and the server then makes a determination of an adverse event.

Upon completion of the data entry, the computer 6 requests a list of dispensing codes for the patient. The dispensing codes are provided by the IVRS/IWRS systems. For example, if the doctor enters that this is patient 21 attending visit 7, the systems will contact the IWRS server and that server will instruct that the doctor dispenses bottle 0012452. The doctor collects bottle 0012452 from the cupboard and scans it, thereby confirming they selected the correct bottle for the patient. There is one dispensing code per bottle or packet of medication. The investigator then scans the medication physically provided to the patient. The computer 6 and/or a server 2 then automatically check the scanned codes against the stored codes for the patient. Integrity of identification of the medication provided to the patient is ensured, even though the investigator does not know whether each medication is a particular product or a placebo.

Other technical features to ensure real time actions and data integrity include a data analytics function which checks if the visit date entered by a user is the date when data have been entered to the system. If there is a date difference greater than two days the visit will be highlighted in red for reporting. Also, the site computer 6 is programmed to receive and capture a hand-written signature of the user or the patient and this is recorded with a patient record.

The following describes by way of pseudo code the major technical functions implemented by the system.

Data Persistence

The system manages data in an array with error flag management as shown by the pseudo code below.

* Find all by entity name.
*/
- (NSArray*) findAllOf:(NSString*) entityName {

NSFetchRequest *fetchRequest = [[NSFetchRequest alloc] init];
[fetchRequest setEntity: [NSEntityDescription entityForName:entityName

inManagedObjectContext:context]];

NSError* error = nil;
NSArray* array = [context executeFetchRequest:fetchRequest error:&error];
if (array == nil) {

NSLog(@“Error while finding %@: %@”, entityName, [error localizedDescription]);

}
return array;

}
- (NSArray*) executeFetchRequest:(NSPredicate*)predicate sortedBy: (NSSortDescriptor*)
sortDescriptor entityName:(NSString*)entityName {

NSFetchRequest *fetchRequest = [[NSFetchRequest alloc] init];
[fetchRequest setEntity:[NSEntityDescription entityForName:entityName

inManagedObjectContext:context]];

[fetchRequest setPredicate:predicate];
if(sortDescriptor) {

[fetchRequest setSortDescriptors:[NSArray arrayWithObject:sortDescriptor]];

}

Each site computer 6 maintains an audit trail of data allowing subsequent answers to questions about the clinical trial Every time when a user of the client application who is in offline mode changes the data state the system will persist a new data state in a separate data table and deliver this when connectivity is reachable.

Connectivity Detection

As noted above, each site computer 6 client application stores data when there is no connectivity. When the client detects that connection is available it will start to submit data from a queue with force communication, as implemented by the code below.

-(BOOL) isServerReachable {

return [self isGlobalServerReachable] && [Session sharedSession}.realmIds != nil;

}
//Called by Reachability whenever status changes.
- (void) reachabilityChanged: (NSNotification* )note
{

Reachability* curReach = [note object];
NSParameterAssert([curReach isKindOfClass: [Reachability class]]);
if ([self isHostReachable:curReach]) {

NSLog(@“forceCommunicationQueueProcessing reachabilityChanged - thread: %@”,

[[NSThread currentThread] name]);

[self forceCommunicationQueueProcessing];

}

}

Uploading Data to Server (Step 29 of FIG. 3, and steps 59 and 71 of FIG. 4)

For data submission to the servers 2, data backup and synchronization is performed as set out below. Data submission is in order to persist and synchronize with other client site computers 6. Every time when connection is available the system will send and persist data in the servers 2.

- (void) sendMessage: (Message *) message {

NSLog(@“\n\nRequest for ODM Message”);
NSLog(@“\n\nXML to send:\n %@\n\n”, [[NSString alloc] initWithData:message.content

encoding: NSUTF8StringEncoding]);
}

Client Monitoring

Each site computer 6 is registered with a monitoring system which traces its GPS location and remotely controls the computer's client software to:
Lock the site computer.
Clear the site computer's data.
Change the password
Locate the site computer via GPS
Change other configuration aspects.

Rendering of form data and validation (steps 22 and 23 of FIG. 3)

The site computer 6 software performs rendering of forms based on CDISK ODM protocol definition. It can render any fields as widget type of:
date
time
close section list (combo list)
text area
checkbox

This allows validating data using value ranges and checking required field values. It also allows dynamic calculations between fields in a form using JavaScript language as formal expression e.g.:

<FormalExpression Context=“FC/EcmaScript”><![CDATA[

return usingValuesFrom(

```
item(“PULMGC.DLCO_BASELINE”).asNumber.isOptional,
item(“PULMGC.DLCO”).asNumber.isOptional,
item(“PULMGC.DLCOML_BASELINE”).asNumber.isOptional,
item(“PULMGC.DLCOML”).asNumber.isOptional,
function(dlcoMmolBaseline, dlcoMmol, dlcoMlBaseline, dlcoMl) {
  var usingMl = dlcoMlBaseline !== undefined || dlcoMl !== undefined;
  var usingMmol = dlcoMmolBaseline !== undefined || dlcoMmol !== undefined;
  if( usingMl && usingMmol ) {
```

return ”;

```
  }
  var baseline = dlcoMmolBaseline || dlcoMlBaseline;
  var dlco = dlcoMmol || dlcoM1;
  if( baseline && dlco) {
```

return (dlco-baseline)/baseline * 100;

```
  }
  return ”;
}
```

)

]] ></FormalExpression>

The site computers analyse data and display decisions to a user based on evaluation of formal expression. Code below (written in JavaScript) presents possibilities:

* Determines whether a warning message/management plan should be shown for a

decision.

```
  * MARK: @method evaluateDecision
  * @private
  * @param {object} decision javascript version of object from Decision.m
  * @param {mixed} value value that was entered into the item
  * @param {string} itemId full ‘:’ separated identifier (from study id to item id) of item the
```

decision belongs to.

* @param {object} contextValues passed along to sandboxWithValues

* @param {function} callback callback function to which the result is passed.

*/
var evaluateDecision = function(decision, value, itemId, contextValues, callback) {

var checkValue = decision.checkValues[0];
//log(‘evaluating ’ + value + ‘ ’ + (decision.comparator || ‘xxx’ ) + ‘ ’ + checkValue);

if( decision.comparator && !value && value !== 0) {

return callback(true);

}

switch(decision.comparator) {

case ‘LT’:return callback(parseFloat(value) < parseFloat(checkValue));
case ‘LE’:return callback(parseFloat(value) <= parseFloat(checkValue));
case ‘GT’:return callback(parseFloat(value) > parseFloat(checkValue));
case ‘GE’:return callback(parseFloat(value) >= parseFloat(check Value));
case ‘EQ’:return callback(parseFloat(value) == parseFloat(checkValue));
case ‘NE’:return callback(parseFloat(value) != parseFloat(check Value));
case ‘IN’:return

callback(decision.checkValues.map(parseFloat).indexOf(parseFloat(value)) >= 0);

itemDef.formatter = function(input) {

return FC.formatDate(input, ‘YYYY MMM dd’);

};
itemField= [{

tag:‘input’,
id: ‘ITEM:’ + itemKey,
name: ‘ITEM:’ + itemKey,
type: ‘hidden’,
properties : {

validationPattern:‘[0-9]{4}-[01][0-9]-[0-3][0-9]’

},
maxlength:10,
listeners: {

filled: function( ) {

this.nextElementSibling.innerText = FC.formatDate(this.value,‘dd MMMM

YYYY’);

Capture Location via Embedded GPS Sensor

As noted above each site computer 6 can track its location in real time. The following is an example of code to implement this in one embodiment. UIImagePickerController*picker=[[UIImagePickerController alloc]init]; picker.sourceType=UIImagePickerControllerSourceTypeCamera; picker. delegate=self; picker.mediaTypes=[UIImagePickerController

availableMediaTypesForSourceType:UIImagePickerControllerSourceTypeCamera];

picker.cameraCaptureMode=UIImagePickerControllerCameraCaptureModeVideo; [self presentViewController:picker animated:YES completion:NULL];

Every time when location of a site computer 6 changes this code will trigger updates.

Awareness of changed location allows triggering location based event e.g.
Doctor left hospital
Lock App when iPad is not in hospital

Manager=[[CLLocationManager alloc]inn];

Manager. delegate=self;

Manager. desiredAccuracy=kCLLocationAccuracyBest;

Manager.distanceFilter=1.0;

[Manager startUpdatingLocation];

[Manager startUpdatingHeading];

-(void)locationManager:(CLLocationManager *)manager
didUpdateToLocation:(CLLocation *)newLocation
fromLocation:(CLLocation *)oldLocation {

userlat = newLocation.coordinate.latitude;
userlon = newLocation.coordinate.longitude;

}

Record Handwritten Signature as a Part of Gesture Capture

The following code allows tracing a user finger path in order to record his or her handwritten signature, for example for consent. After that, the system converts this into JPEG image. The signature is assigned to the user. Every time when security requires the investigator or the patient to sign a document this can be done with a written signature.

#pragma mark - Actions
-(IBAction)acceptSignature:(id)sender {

UIImage *signatureImage = [self.signatureDrawing View getSignatureImage] ;
NSString *signaturePath = [dirPath stringByAppendingPathComponent:fileName];
[UIImageJPEGRepresentation(signatureImage, 1.0) writeToFile:signaturePath

atomically:YES];

[self dismissViewControllerAnimated:true completion:nil];

}

Client captures patient data based on forms rendered based on CDISK ODM specification. Think client allows storing data when there is no connectivity.

Generate PDF (Step 60, FIG. 4)

Generate Patient Data to PDF snippet of code below using objective C:

UIGraphicsBeginPDFContextToFile( . . . );

UIGraphicsBeginPDFPageWithlnfo( . . . );

UIGraphicsBeginPDFPageWithInfo( . . . );

UIGraphicsEndPDFContext( )

Submit to EDC (Step 61)

The servers 2 allow connecting to an EDC system 5 in order to submit data, and the code below which is written in Java illustrates this:

private HttpClient httpClient;
private static final ServerLogger logger = ServerLogger

.create(OdmMessageRaveUpdateSubjectClient.class);

/**
* Default constructor.

OdmMessageProcessingOutcome odmClientResponse = null;
setupCreditionals(seviceEndPoint.createCredentials( ));
PostMethod postMethod = createPostMethod(seviceEndPoint.getServiceUrl( ));
try{

String odmXml = OdmUtility.marshal(message.getODMQ);
postMethod.setRequestEntity(createRequestEntity(odmXml));
int statusCode = httpClient.executeMethod(postMethod);
odmClientResponse = createResponse(statusCode, postMethod);
processResponse(message, odmClientResponse);

} catch (IOException ioe) {

logger.exception(“IOException”, ioe, postMethod.getPath( ).toString( ));

Decision Support

The site computers 6 support decisions generated on the basis of on evaluation of conditions. The code below demonstrates processing of client data in order to detect decision

@Override

public OdmMessageProcessingOutcome delegate(ServiceEndPoint serviceEndPont,

OdmMessage message) {

String patientNumber = odmUtility.getFirstSubjectScreeningNumberFromOdmMessage(

message.getODM( ) );

Patient patient =

patientDao.findPatientByStudyGoidAndScreeningNumber(message.getGoid( ), patientNumber);

Set<ItemDataPathKey> itemDataPathsFromOdm =

odmUtility.generateItemDataPaths(message.getODM( ));

for( EventDefinition eventDefinition : affectedEventDefinitions ) {

eventProcessor.processEventDefinition( message, patient, eventDefinition );

}
return createProcessingOutcomeMarkingItIgnoredIf( affectedEventDefinitions.isEmpty( ) );
}

Notify User

@Override

public String processAction(

Action action, Patient patient, Map<String, Object> variables

) {

Cycles Support (FIG. 4)

Organizing visits content into cycles.

Code below presents visit organized into cycles:

//
// VisitsFolderView.m
// VBVG
//

//is a folderCurrentlyOpen
NSMutableArray *thumbnailIconArray;
float folderOpenedHeight;
int numOfIconsInRow;

}

(void) moveIconsBelowFolderDown: (float) iconFolderWillPointTo_Y distanceToBeMoved: (float) distance;
(void) moveIconsUp: (float) distance;
(void) moveIconslnLowerRows: (DIRECTION) direction;
(void) greyNotSelectedIcons;
(void) unGreyAllIcons;
(void) doScrollAnimateToOffset: (float) contentOffset forDuration: (NSTimeInterval) duration;
(void) createFolderandArrow;
(void) layoutArrowAndFolder;
(void) openFolder:(id)sender animate:(BOOL) animate;
(void) cycleIconTapped:(id)sender animate:(BOOL) animate;
(void) updateFolderSizeAfterRotate;

//Top Level Icons
- (UIButton*) createIconCell : (int) rowCounter inColumn : (int) columnCounter iconIndex :
(int)iconIndex forFolder : (Folder*) folder

maxNumIconsInRow : (int) maxNumIconsInRow;

//Folder Icon
- (UIImage*) layoutFolderContainerIcon:(NSMutableArray*) icons withFrame: (CGRect)
frame;
- (void) createlconlnsideFolderlcon : (Icon*) folderIcon inRow : (int) rowCounter inColumn :
(int) columnCounter iconIndex : (int) folderIconIndex maxNumIconsInRow : (int)
maxNumIconsInRowInFolderIcon addtoView:(UIView *)view;
-(BOOL) shouldIconBeHighlighted : (VisitType) visitType {

if( visitType == ADDITIONALCYCLE_VISIT || visitType == SCHEDULED_VISIT) {

Formal Expression (FIG. 4, Step 55)

The site computers 6 have embedded language which allows extension validation and decision support based on configuration. This language provides a custom validation, which will be injected and interpreted by a code executor.

The example below shows detection and alerting a pulmonary an AE based on value boundaries including simple calculation formula.

<FormalExpression Context=“FC/EcmaScript”><![CDATA[

return usingValuesFrom(

item(“PULMGC.FVC_BASELINE”).asNumber,
item(“PULMGC.FVC”).asNumber,
function(baseline, value) {
return (value-baseline)/baseline * 100;
}

)
]] ></FormalExpression>

</MethodDef>
<MethodDef OID=“PULMGC.DLCOCHANGE_CALC”

return (dlco-baseline)/baseline * 100;

}
return ”;

}

)
]] ></FormalExpression>

It will be appreciated that the invention provides a technical platform for both improved automation and data integrity for clinical trial data capture. There is also improved notification of information to concerned parties.

It will be appreciated that the system allows an investigator to continue with a trial visit even if the computer 6 is offline. In such circumstances the investigator is ensured to have:
A unique patient enrolment code,
full consent processing (15 in FIG. 2),
full screening (16 in FIG. 2),
automatic scheduling and re-scheduling,
automatic assimilation of data from a range of patients, without confidentially breach to provide a distribution plot as a tool for the investigator to make an informed decision;
based on the above, automatic modification of thresholds for patient screening

The invention is not limited to the embodiments described but may be varied in construction and detail.

1. A clinical trial data capture system comprising:
a plurality of clinical site computers, each configured to be registered with a clinical trial site and having thick client software, and
a server is configured to receive clinical data from the site computers and to analyse said data in real time, wherein at least one site computer:
includes location tracking capability and is configured to automatically upload location data to the server, and the server is configured to log said data,
is configured to automatically upload patient site visit data to the server, and to also save site visit data to a document and to upload said document to the server, and
has a camera and is configured to capture an image related to a clinical visit and to upload said image with associated clinical visit data.

2. The clinical trial data capture system as claimed in claim 1, wherein the server and/or at least one site computer are configured to automatically determine if a site computer is outside of an allowed region, indicating unauthorised use; and wherein the server is configured to, if a site computer is outside of an allowed region, lock the site computer, or clear the site computer's data, or change the computer's access credentials.

3. The clinical trial data capture system as claimed in claim 1, wherein at least one site computer is configured to block re-entry of data to a field according to data validation criteria, and wherein the site computer is configured to automatically detect attempted image editing and to upload corresponding alerts to the server.

4. The clinical trial data capture system as claimed in claim 1, wherein at least one site computer is configured to block re-entry of data to a field according to data validation criteria; and wherein at least one site computer is configured to analyse data and display decisions based on evaluation of formal expression.

5. The clinical trial data capture system as claimed in claim 1, wherein at least one site computer and/or the server are configured to automatically detect a medical adverse event by analysis of inputted patient data.

6. The clinical trial data capture system as claimed in claim 1, wherein at least one site computer is configured to perform the following steps:
receive an entry of a patient data,
dynamically carry out a plausibility check by comparing the entered data with allowed ranges, and
if the automatic analysis reveals that the patient candidate should not be accepted, but with only a small margin on some parameter, generate a distribution plot for this parameter over a number of candidates, and
upload said distribution plot data to the server, and
wherein the server is configured to then make a determination as to candidate eligibility and compares it to that made by the site computer.

7. The clinical trial data capture system as claimed in claim 1, wherein at least one site computer is configured to maintain an audit trail of data allowing subsequent answers to questions about a clinical trial, wherein every time when a user who is in offline mode changes the data state the computer will persist a new data state in a separate data table and deliver this when connectivity to the server is possible.

8. The clinical trial data capture system as claimed in claim 1, wherein at least one site computer is configured to maintain an audit trail of data allowing subsequent answers to questions about a clinical trial, wherein every time when a user who is in offline mode changes the data state the computer will persist a new data state in a separate data table and deliver this when connectivity to the server is possible; and wherein the site computer (6) is configured to perform rendering of forms based on an operational data model protocol definition to render any fields as a widget type of date or time or a close section list or a text area or a checkbox, and the site computer is configured to perform data validation using value ranges and checking required field values and to automatically perform dynamic calculations between fields in a form.

9. The clinical trial data capture system as claimed in claim 1, wherein at least one site computer is configured to maintain an audit trail of data allowing subsequent answers to questions about a clinical trial, wherein every time when a user who is in offline mode changes the data state the computer will persist a new data state in a separate data table and deliver this when connectivity to the server is possible; and wherein the site computer (6) is configured to perform rendering of forms based on an operational data model protocol definition to render any fields as a widget type of date or time or a close section list or a text area or a checkbox, and the site computer is configured to perform data validation using value ranges and checking required field values and to automatically perform dynamic calculations between fields in a form; and wherein the site computer is configured to use JavaScript language as formal expression to perform said validation.

10. The clinical trial data capture system as claimed in claim 1, wherein at least one site computer is configured to automatically perform cycle management by maintaining a workflow per patient.

11. The clinical trial data capture system as claimed in claim 1, wherein at least one site computer is configured to automatically perform cycle management by maintaining a workflow per patient; and wherein at least one site computer is configured to automatically impose a consent gate through to subsequent workflow stages of patient treatment with n visits V₁ . . . Vᵢ . . . Vₙ, and treatment follow-up.

12. The clinical trial data capture system as claimed in claim 1, wherein at least one site computer is configured to automatically perform cycle management by maintaining a workflow per patient; and wherein at least one site computer is configured to automatically impose a discontinue gate before entering the follow-up stage.

13. The clinical trial data capture system as claimed in claim 1, wherein at least one site computer is configured to automatically perform cycle management by maintaining a workflow per patient; and wherein at least one site computer is configured to dynamically modify a visit schedule to generate data for a next visit Vᵢ₊₁, and wherein said data includes clinical instructions dynamically retrieved from a configured clinical instruction profile.

14. The clinical trial data capture system as claimed in claim 1, wherein at least one site computer is configured to automatically perform cycle management by maintaining a workflow per patient; and wherein a decision to schedule a next visit Vᵢ₊₁ is triggered according to comparison of clinical data with thresholds.

15. The clinical trial data capture system as claimed in claim 1, wherein at least one site computer is configured to automatically perform cycle management by maintaining a workflow per patient; and wherein the consent gate requires patient inputs confirming understanding of each of a plurality of topics, and a sub-gate is imposed to prevent automatic generation of a consent form until all topics are confirmed to be understood by the patient; and wherein at least one site computer is configured to generate a display of summarising topic headers adjacent a patient-understanding input, thereby prompting the investigator to explain further.

16. The clinical trial data capture system as claimed in claim 1, wherein at least one site computer is configured to automatically perform cycle management by maintaining a workflow per patient; and wherein at least one site computer is configured to generate the consent form with patient data and topic data and a control for touch-screen writing of a consent signature; and wherein at least one site computer is configured to impose a sub-gate for investigator witnessing of the consent signature before progressing beyond the consent stage.

17. The clinical trial data capture system as claimed in claim 1, wherein the server is configured to perform electronic data capture by automatically transferring processed and raw data to an external EDC system.

18. The clinical trial data capture system as claimed in claim 1, wherein at least one site computer is configured to download a batch of enrolment codes and of randomisation codes and store them locally, in which there is one code per patient, and to make said codes available even if the site computer is offline, and wherein at least one site computer is configured to automatically synchronize with a server when next online, by uploading which codes have been used; and wherein at least one site computer is configured to automatically download a fresh batch of enrolment and randomisation codes during said synchronization.

19. The clinical trial data capture system as claimed in claim 1, wherein at least one site computer is configured to, upon completion of a data entry, request a list of dispensing codes for the patient from the server or from an interactive response system, allowing only one dispensing code per bottle or packet of medication, and wherein at least one site computer is configured to capture a scanned identifier of medication physically provided to the patient, and the site computer and/or a server are configured to automatically check the scanned identifiers against inputted codes for the patient.

20. A clinical trial data capture system comprising:
a plurality of clinical site computers, each configured to be registered with a clinical trial site and having thick client software, and
a server configured to receive clinical data from the site computers and to analyse said data in real time,
wherein at least one site computer and/or the server are configured to automatically detect a medical adverse event by analysis of inputted patient data,
wherein at least one site computer is configured to perform the following steps:
receive an entry of a patient data,
dynamically carry out a plausibility check by comparing the entered data with allowed ranges, and
if the automatic analysis reveals that the patient candidate should not be accepted, but with only a small margin on some parameter, generate a distribution plot for this parameter over a number of candidates, and
upload said distribution plot data to the server, and
wherein the server is configured to then make a determination as to candidate eligibility and compares it to that made by the site computer.

21. A clinical trial data capture system comprising:
a plurality of clinical site computers, each configured to be registered with a clinical trial site and having thick client software, and
a server configured to receive clinical data from the site computers and to analyse said data in real time,
wherein at least one site computer is configured to download a batch of enrolment codes and of randomisation codes and store them locally, in which there is one code per patient, and to make said codes available even if the site computer is offline, and wherein at least one site computer is configured to automatically synchronize with a server when next online, by uploading which codes have been used; and wherein at least one site computer is configured to automatically download a fresh batch of enrolment and randomisation codes during said synchronization,
wherein at least one site computer is configured to, upon completion of a data entry,
request a list of dispensing codes for the patient from the server or from an interactive response system, allowing only one dispensing code per bottle or packet of medication, and wherein at least one site computer is configured to capture a scanned identifier of medication physically provided to the patient, and the site computer and/or a server are configured to automatically check the scanned identifiers against inputted codes for the patient.
